(19) United States
(12) Patent Application Publication
(10) Pub. No.: US 2015/0277329 A1
(43) Pub. Date: Oct. 1, 2015

(54) AUTOMATIC DOCUMENT FEEDER

(71) Applicant: Primax Electronics Ltd., Neihu (TW)

(72) Inventor: NIEN-HUA PAI, Neihu (TW)

(21) Appl. No.: 14/335,594

(22) Filed: Jul. 18, 2014

(30) Foreign Application Priority Data
Mar. 28, 2014 (TW) 103111694

(51) Int. Cl. G03G 15/00; B65H 7/00

(52) U.S. Cl. CPC G03G 15/607; B65H 7/00

(57) ABSTRACT

An automatic document feeder includes an upper cover, a conveying channel, and a document detecting module. The document detecting module includes a metal element, a coil, a detecting circuit, and a controlling unit. The metal element is located at a first side of the conveying channel. The coil, the detecting circuit and the controlling unit are all located at a second side of the conveying channel. While one or more paper sheets are transferred through the document detecting module, the metal element is pushed, so that the magnetic force generated by the coil is subjected to a change. A change amount of the magnetic force value is detected by the detecting circuit. If the change amount of the magnetic force value is larger than a predetermined magnetic force value, the controlling unit judges that the multi feeding condition occurs.

### FIELD OF THE INVENTION

The present invention relates to an automatic document feeder, and more particularly to an automatic document feeder for a scanning apparatus.

### BACKGROUND OF THE INVENTION

With increasing development of scientific technologies, the method for storing paper sheets is changed from the filing of paper sheets to the storage of the electronic files of the paper sheets. Generally, a scanning apparatus is a device for scanning the contents of paper sheets into electronic files. The electronic files are further spread, processed or stored.

In the early stage, the scanning apparatus can only scan one side of the paper sheet. For scanning both sides of the paper sheet, after one side of the paper sheet has been scanned, the paper sheet should be manually turned over so as to scan the other side of the paper sheet. However, the process of manually turning over the paper sheet is troublesome. For solving the drawbacks, an automatic document feeder is usually integrated into a flatbed scanning apparatus. Consequently, a stack of paper sheets can be successively transferred by the automatic document feeder and a duplex scanning operation can be performed by the flatbed scanning apparatus without the need of manually turning over the paper sheets. The automatic document feeder is not only used with the scanning module of the scanning apparatus. Nevertheless, the automatic document feeder may be used with a printing module of a printing apparatus.

Conventionally, the automatic document feeder and the flatbed scanning apparatus are integrated as a sheet-feeding type scanning apparatus. Hereinafter, the structure of a conventional sheet-feeding type scanning apparatus with the automatic document feeder will be illustrated with reference to FIG. 1. FIG. 1 is a schematic side view illustrating an automatic document feeder and a flatbed scanning apparatus of a conventional sheet-feeding type scanning apparatus. As shown in FIG. 1, the conventional automatic document feeder 1 comprises a document pick-up module 10, an upper cover 11, a friction pad 12, a conveying channel 13, a document input tray 14, a document discharge tray 15, plural conveying roller assemblies 16, and a document discharge roller assembly 17. The document input tray 14 is used for placing plural paper sheets S thereon. The document discharge tray 15 is disposed under the document input tray 14. After the plural paper sheets S are scanned, the scanned paper sheets S are placed on the document discharge tray 15. The document pick-up module 10 is disposed under the upper cover 11 for transferring the plural paper sheets S from the document input tray 14 into the conveying channel 13. The document pick-up module 10 comprises a pick-up roller 101 and a separation roller 102. The pick-up roller 101 is used for contacting the plural paper sheets S, thereby transferring the plural paper sheets S. The separation roller 102 is used for separating the uppermost paper sheet S from the underlying paper sheets S, so that only a single paper sheet S is fed into the conveying channel 13 at each time. The friction pad 12 is disposed under the separation roller 102 for providing a friction force to the paper sheet S that is in contact with the friction pad 12, thereby assisting in the separation roller 102 to transfer a single paper sheet S into the conveying channel 13.

The plural conveying roller assemblies 16 are disposed in the conveying channel 13 for moving the plural paper sheets S along the conveying channel 13. The document discharge roller assembly 17 is located near the document discharge tray 15 for ejecting the plural paper sheets S to the document discharge tray 15. The flatbed scanning apparatus 2 is disposed under the automatic document feeder 1. The flatbed scanning apparatus 2 comprises a scanning module 20. The conveying channel 13 runs through a region over the scanning module 20. Consequently, when the paper sheet S is transferred across the region over the scanning module 20, the paper sheet S is scanned by the scanning module 20.

Hereinafter, the operations of the automatic document feeder 1 will be illustrated with reference to FIG. 1. When the conventional automatic document feeder 1 is operated in a normal working mode, the document pick-up module 10 is swung downwardly to be distant from the upper cover 11 by using the separation roller 102 as a fulcrum. Consequently, the pick-up roller 101 of the document pick-up module 10 is contacted with the plural paper sheets S on the document input tray 14, thereby transferring the plural paper sheets S. During the process of transferring the plural paper sheets S by the pick-up roller 101, the uppermost paper sheet S of the plural paper sheets S is contacted with the separation roller 102, and the lowermost paper sheet S of the plural paper sheets S is contacted with the friction pad 12. In response to the friction force provided by the friction pad 12, the uppermost paper sheet S is separated from the underlying paper sheets and fed into the conveying channel 13.

Next, the paper sheet S is transferred by the plural conveying roller assemblies 16, so that the paper sheet S is moved along the conveying channel 13. When the paper sheet S is moved across the region over the scanning module 20, the paper sheet S is scanned by the scanning module 20, so that a scanned image of the paper sheet S is acquired. Afterwards, the scanned paper sheet S is transferred by the document discharge roller assembly 17 and ejected to the document discharge tray 15. Under this circumstance, the scanning operation on the uppermost paper sheet S is completed. The processes of scanning the remaining paper sheets S are similar to the above process, and are not redundantly described herein. After the plural paper sheets S are scanned, the plural paper sheets S may be removed from the document discharge tray 15.

However, after the conventional automatic document feeder 1 has been used for a long time, the function thereof is deteriorated because the pick-up roller 101, the separation roller 102 and the friction pad 12 are frequently abraded. Consequently, a so-called double feeding or multi feeding condition occurs when a stack of paper sheets are fed into the sheet-feeding type scanning apparatus. Once the double feeding or multi feeding condition occurs, two or more paper sheets are simultaneously fed into the sheet-feeding type scanning apparatus. For example, if the double feeding condition occurs, the second paper sheet to be fed is partially or completely superimposed with the first paper sheet. Under this circumstance, the second paper sheet is incompletely scanned or fails to be scanned. In other words, the double feeding or multi feeding condition is troublesome to the user.

Therefore, there is a need of providing an improved automatic document feeder capable of detecting whether the multi feeding condition occurs.

### SUMMARY OF THE INVENTION

The present invention provides an automatic document feeder capable of detecting whether a multi feeding condition occurs.

In accordance with an aspect of the present invention, there is provided an automatic document feeder for successively transferring plural paper sheets to a scan region of a scanning module. The automatic document feeder includes a main body, an upper cover, a document input tray, a document discharge tray, a conveying channel, and a document detecting module. The upper cover may partially cover the main body. The document input tray is connected with the main body. Moreover, plural paper sheets are placed on the document input tray. The document discharge tray is disposed on the main body. After the plural paper sheets are transferred through the scan region, the plural paper sheets are placed on the document discharge tray. The conveying channel is arranged between the document input tray and the document discharge tray and disposed under the upper cover. The plural paper sheets are permitted to be transferred through the conveying channel. The document detecting module is disposed in the conveying channel, and detects whether a multi feeding condition occurs. The document detecting module includes a metal element, a coil, a detecting circuit, and a controlling unit. The metal element is located at a first side of the conveying channel. The coil is located at a second side of the conveying channel, and generates a magnetic force in response to an electromagnetic effect. The detecting circuit is located at the second side of the conveying channel and connected with the coil. The detecting circuit provides an electric current to the coil to have the coil generate the electromagnetic effect. Alternatively, the detecting circuit detects a first magnetic force value or a second magnetic force value when the metal element is not pushed by any paper sheet or the metal element is pushed by one or more of the plural paper sheets. The controlling unit is located at the second side of the conveying channel and connected with the detecting circuit. The controlling unit judges whether the multi feeding condition occurs according to a change amount between the first magnetic force value and the second magnetic force value. If the charge amount is larger than a predetermined magnetic force value, the controlling unit judges that the multi feeding condition occurs.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side view illustrating an automatic document feeder and a flatbed scanning apparatus of a conventional sheet-feeding type scanning apparatus;

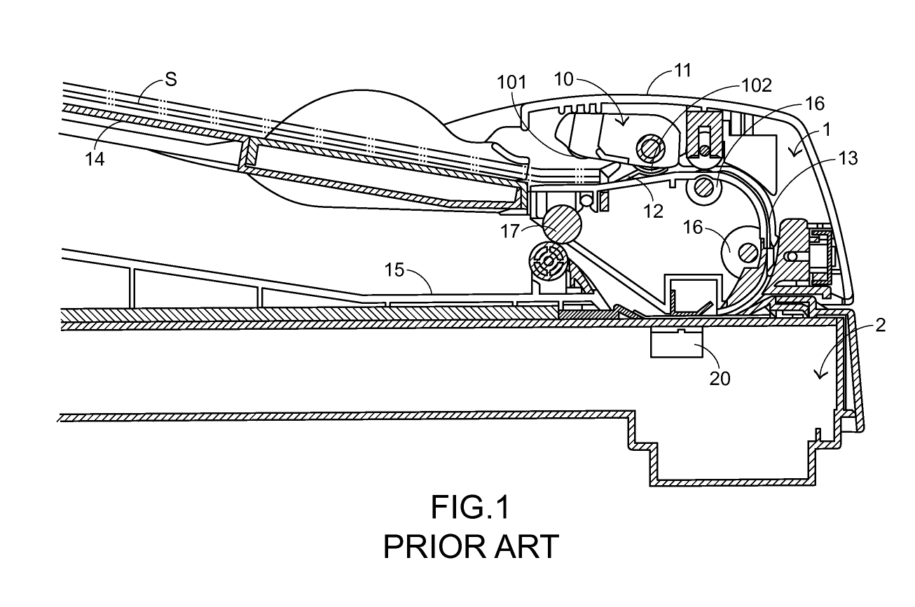

FIG. 2 is a schematic side view illustrating a sheet-feeding type scanning apparatus with an automatic document feeder according to a first embodiment of the present invention, in which the automatic document feeder is in a standby status;

FIG. 3 schematically illustrates the document detecting module of the automatic document feeder according to the first embodiment of the present invention;

FIG. 4 schematically illustrates the upper cover and the metal element of the automatic document feeder according to the first embodiment of the present invention;

FIG. 5 is a schematic side view illustrating the automatic document feeder in a feeding status according to the first embodiment of the present invention;

FIG. 6 is a schematic side view illustrating a sheet-feeding type scanning apparatus with an automatic document feeder according to a second embodiment of the present invention, in which the automatic document feeder is in a feeding status; and

FIG. 7 schematically illustrates the upper cover and the metal element of the automatic document feeder according to the second embodiment of the present invention.

### DETAILED DESCRIPTION OF THE PREFERRED EMBODIMENT

For eliminating the drawbacks from the conventional technology, the present invention provides an automatic document feeder capable of detecting whether a multi feeding condition occurs.

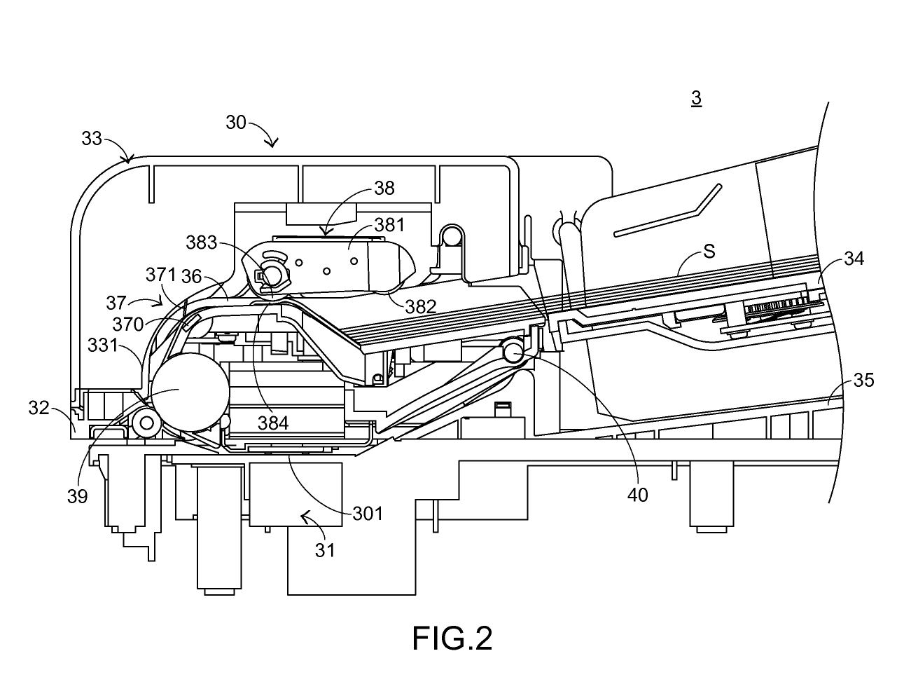

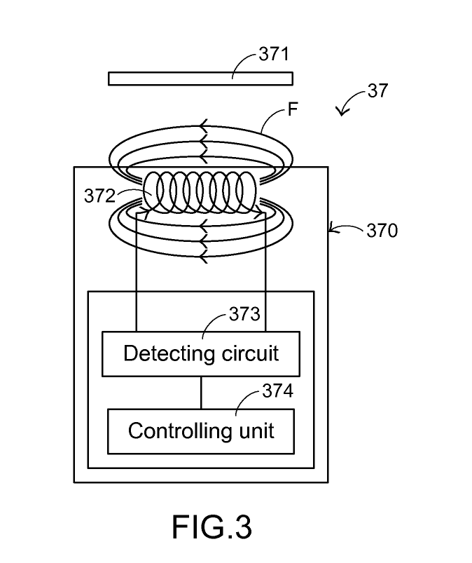

FIG. 2 is a schematic side view illustrating a sheet-feeding type scanning apparatus with an automatic document feeder according to a first embodiment of the present invention, in which the automatic document feeder is in a standby status. As shown in FIG. 2, a sheet-feeding type scanning apparatus 3 comprises an automatic document feeder 30 and a scanning module 31. The scanning module 31 is used to successively scanning plural paper sheets S and generating plural scanned images of the plural paper sheets S. The automatic document feeder 30 is disposed over the scanning module 31 for successively transferring the plural paper sheets S to a scan region 301 of the scanning module 31. As shown in FIG. 3, the automatic document feeder 30 comprises a main body 32, an upper cover 33, a document input tray 34, a document discharge tray 35, a conveying channel 36, a document detecting module 37, a document pick-up module 38, a conveying roller assembly 39, and a document discharge roller assembly 40. A portion of the main body 32 is covered by the upper cover 33. The document input tray 34 is connected with the main body. In addition, the document input tray 34 is used for placing the plural paper sheets S thereon. The document discharge tray 35 is disposed on the main body 32 and disposed under the document input tray 34. After the plural paper sheets S are transferred across the scan region 301 and scanned by the scanning module 31, the scanned paper sheets S are placed on the document discharge tray 35. The conveying channel 36 is arranged between the document input tray 34 and the document discharge tray 35 and disposed under the upper cover 33 for allowing the plural paper sheets S to go through.

Please refer to FIG. 2 again. The document pick-up module 38 is arranged between the document input tray 34 and the conveying channel 36 for transferring the plural paper sheets S from the document input tray 34 into the conveying channel 36. The document pick-up module 38 comprises a pick-up arm 381, a pick-up roller 382, a separation roller 383, and a friction element 384. The pick-up arm 381 is disposed over a first side of the conveying channel 36. Moreover, the pick-up arm 381 may be swung relative to the conveying channel 36 so as to be close to the conveying channel 36 or distant from the conveying channel 36. The pick-up roller 382 is disposed on the pick-up arm 381 and located near the document input tray 34. As the pick-up arm 381 is swung and the pick-up roller 382 is contacted with the plural paper sheets S, the plural paper sheets S are successively fed into the conveying channel 36. The separation roller 383 is disposed on the pick-up arm 381 and arranged beside the pick-up roller 382. The separation roller 383 is used for separating the plural fed paper sheets S, so that only a single paper sheet S is fed into the conveying channel 36 at each time. The friction element 384 is located at a second side of the conveying channel 36 for providing a friction force to the paper sheet S, thereby assisting in the separation roller 383 to transfer a single paper sheet S into the conveying channel 36. In other words, by the separation roller 383 and the friction element 384, only a single paper sheet S is allowed to be fed into the conveying channel 36 by the document pick-up module 38 during each feeding operation (i.e. the normal feeding condition). The conveying roller assembly 39 is disposed in the conveying channel 36 for successively transferring the plural paper sheets S to the scan region 301. The document discharge roller assembly 40 is disposed in the conveying channel 36 and located near the document discharge tray 35. After the plural paper sheets S are transferred across the scan region 301, the plural paper sheets S are ejected to the document discharge tray 35. In this embodiment, the friction element 384 is a friction pad, but is not limited thereto. In another embodiment, the friction element is a friction roller.

FIG. 3 schematically illustrates the document detecting module of the automatic document feeder according to the first embodiment of the present invention. Please refer to FIGS. 2 and 3. The document detecting module 37 is disposed in the conveying channel 36 for detecting whether a multi feeding condition occurs. The document detecting module 37 comprises a metal element 371, a coil 372, a detecting circuit 373, and a controlling unit 374. The metal element 371 is installed on the upper cover 33 and swingable relative to the upper cover 33. Moreover, the metal element 371 is located at the first side of the conveying channel 36. The coil 372 is located at the second side of the conveying channel 36. When an electric current flows through the coil 372, an electromagnetic effect is generated. Due to the electromagnetic effect, a magnetic force F is generated. The detecting circuit 373 is located at the second side of the conveying channel 36 and connected with the coil 372. The detecting circuit 373 has two functions. Firstly, the detecting circuit 373 may provide the electric current to the coil 372, so that the coil 372 generates the electromagnetic effect. Secondly, by judging whether the metal element 371 is pushed by the single paper sheet S or the plural paper sheets S, the detecting circuit 373 detects a first magnetic force value or a second magnetic force value. In case that the metal element 371 is not pushed by any paper sheet S, the magnetic force value detected by the detecting circuit 373 is the first magnetic force value. Whereas, in case that the metal element 371 is pushed by the single paper sheet S or the plural paper sheets S, the magnetic force value detected by the detecting circuit 373 is the second magnetic force value. Moreover, as the number of the paper sheets S pushing the metal element 371 is changed, the magnitude of the second magnetic force value is correspondingly changed.

The controlling unit 374 is located at the second side of the conveying channel 36 and connected with the detecting circuit 373. According to a change amount between the first magnetic force value and the second magnetic force value, the controlling unit 374 judges whether a multi feeding condition occurs. In particular, according to a relationship between the change amount and a predetermined magnetic force value, the controlling unit 374 may judge whether the multi feeding condition occurs. The approach of setting the predetermined magnetic force value will be illustrated later. In this embodiment, the metal element 371 is a metal sheet, which is made of copper or aluminum. Moreover, the coil 372, the detecting circuit 373 and the controlling unit 374 are integrated into a circuit board 370.

In other words, the document detecting module 37 may judge whether the multi feeding condition occurs according to the change of the magnetic force value. For example, if the metal element 371 is not pushed by any paper sheet S, i.e. no paper sheet S is transferred through the document detecting module 37, a first magnetic force value (e.g. A) is detected by the detecting circuit 373. Whereas, if the metal element 371 is pushed by one paper sheet S, a second magnetic force value (e.g. A+B) is detected by the detecting circuit 373. Whereas, if the metal element 371 is pushed by two paper sheets S, another second magnetic force value (e.g. A+2B) is detected by the detecting circuit 373. Consequently, if the change amount between the first magnetic force value and the second magnetic force value is equal to B, the controlling unit 374 judges that the feeding condition is normal. On the other hand, if the change amount between the first magnetic force value and the second magnetic force value is larger than B (e.g. 2B or higher), the controlling unit 374 judges that the multi feeding condition occurs. In this embodiment, the predetermined magnetic force value in the controlling unit 374 is B. That is, the predetermined magnetic force value is equal to the change amount corresponding to one paper sheet S.

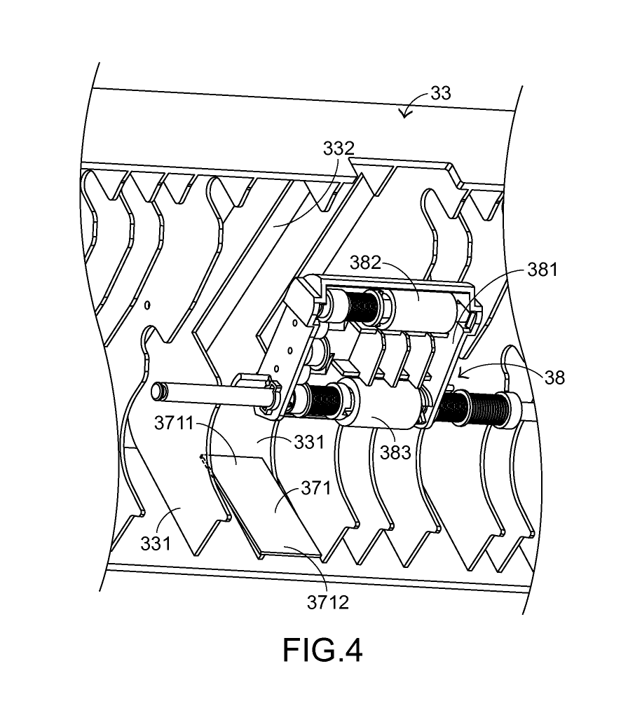

Hereinafter, the position of the metal element 371 will be illustrated with reference to FIGS. 2 and 4. FIG. 4 schematically illustrates the upper cover and the metal element of the automatic document feeder according to the first embodiment of the present invention. In FIG. 4, the upper cover 33 of the automatic document feeder 30 is shown. The upper cover 33 comprises plural guide slices 331. The plural guide slices 331 are disposed on an inner surface 332 of the upper cover 33. Moreover, the plural guide slices 331 are perpendicular to the inner surface 332 of the upper cover 33. When the main body 32 is partially covered by the upper cover 33, the plural guide slices 331 are disposed over the conveying channel 36. The metal element 371 is arranged between two of the plural guide slices 331. A first end 3711 of the metal element 371 is fixed on the two guide slices 331. In addition, a second end 3712 of the metal element 371 is located at the first side of the conveying channel 36. Consequently, while the paper sheet S is moved along the conveying channel 36 and transferred through the document detecting module 37, the metal element 371 is pushed by the paper sheet S. When the second end 3712 of the metal element 371 is pushed by the paper sheet S, the second end 3712 of the metal element 371 is swung relative to the first end 3711 of the metal element 371. Under this circumstance, the second magnetic force value is detected by the detecting circuit 373.

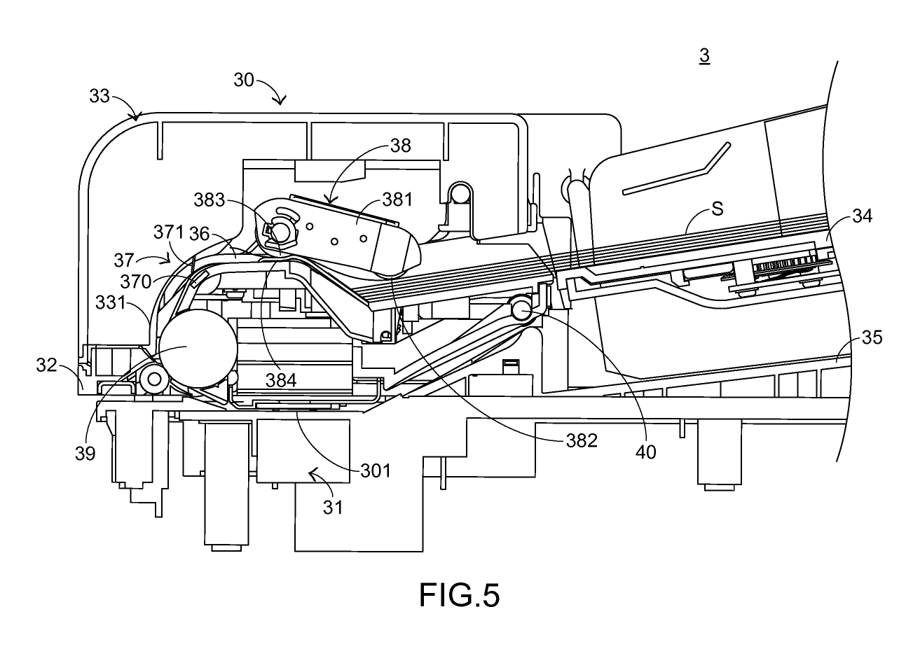

FIG. 5 is a schematic side view illustrating the automatic document feeder in a feeding status according to the first embodiment of the present invention. Please refer to FIGS. 2 and 5. Before the plural paper sheets S are scanned by the sheet-feeding type scanning apparatus 3, the detecting circuit 373 has to detect the first magnetic force value in the situation that no paper sheet S is transferred through the document detecting module 37 and detect the second first magnetic force value in the situation that one paper sheet S is transferred through the document detecting module 37. Consequently, the controlling unit 374 may obtain the change amount between the first magnetic force value and the second magnetic force value and set the change amount as the predetermined magnetic force value. After the predetermined magnetic force value is set, the pick-up arm 381 of the automatic document feeder 30 is distant from the conveying channel 36. Consequently, the plural paper sheets can be placed on the document input tray 34. Under this circumstance, the automatic document feeder 30 is in the standby status (see FIG. 2).

When the automatic document feeder 30 is operated in a normal working mode, the pick-up arm 381 is swung downwardly to be distant from the upper cover 33 by using the separation roller 383 as a fulcrum. Consequently, the pick-up roller 382 is contacted with the plural paper sheets S on the document input tray 34. Under this circumstance, the automatic document feeder 30 is in the feeding status (see FIG. 5). At the same time, the document detecting module 37 is enabled. Since no paper sheet S is transferred through the document detecting module 37, the magnetic force value that is continuously detected by the detecting circuit 373 is equal to the first magnetic force value (e.g. A). Then, the plural paper sheets S are successively fed by the pick-up roller 382. During the process of transferring the plural paper sheets S by the pick-up roller 382, the uppermost paper sheet S of the plural paper sheets S is contacted with the separation roller 383, and the lowermost paper sheet S of the plural paper sheets S is contacted with the friction element 384. In response to the friction force provided by the friction element 384, the plural paper sheets S are separated. In this embodiment, the frictional force between the separation roller 383 and the paper sheet S is larger than the frictional force between the paper sheet S and the friction element 384, and the frictional force between the paper sheet S and the friction element 384 is larger than the frictional force between the plural paper sheets S. Since the frictional forces are specially designed, only the uppermost paper sheet S is allowed to be fed into the conveying channel 36.

Then, the paper sheet S is moved along the conveying channel and transferred through the document detecting module 37.

Meanwhile, the second end 3712 of the metal element 371 at the first side of the conveying channel 36 is pushed by the paper sheet S. Consequently, the second end 3712 of the metal element 371 is swung relative to the first end 3711 of the metal element 371. As the metal element 371 is swung, the electromagnetic effect generated by the coil 372 is subjected to a change. Since one paper sheet S is transferred through the document detecting module 37, the magnetic force value detected by the detecting circuit 373 is changed from the first magnetic force value to the second magnetic force value (e.g. A+B). Meanwhile, the change amount (i.e. B) between the first magnetic force value and the second magnetic force value is compared with the predetermined magnetic force value by the controlling unit 374. Since both of the change amount and the predetermined magnetic force value are equal to B, the controlling unit 374 judges that the feeding condition is normal. Under this circumstance, the feeding procedure is continuously performed.

After the paper sheet S is completely transferred through the document detecting module 37, the metal element 371 is no longer pushed by the paper sheet S. Consequently, the metal element 371 is swung to the original position where the metal element 371 is not swung. Meanwhile, the magnetic force value detected by the detecting circuit 373 is changed to the first magnetic force value again. Moreover, by the conveying roller assembly 39, the paper sheet S is transferred through the scan region 301 of the scanning module 31. On the other hand, while the paper sheet S is transferred through the scan region 301, the paper sheet S is scanned by the scanning module 31. Consequently, a scanned image of the paper sheet S is acquired. Afterwards, the scanned paper sheet S is transferred by the document discharge roller assembly 40 and ejected to the document discharge tray 35. Under this circumstance, the scanning operation on the uppermost paper sheet S has been completed. The situation that no multi feeding condition occurs has been mentioned above.

Next, the operations of the automatic document feeder 30 in the multi feeding condition will be illustrated. For example, the operation status of the multi automatic document feeder 30 is switched from the standby status of FIG. 2 to the feeding status of FIG. 5, and plural paper sheets S (e.g. two paper sheets S) are fed into the conveying channel 36. When the two paper sheets S are transferred through the document detecting module 37, the second end 3712 of the metal element 371 at the first side of the conveying channel 36 are pushed by the two paper sheets S. Consequently, the second end 3712 of the metal element 371 is swung relative to the first end 3711 of the metal element 371. The swinging degree of the second end 3712 of the metal element 371 is larger than the swinging degree of the above situation that the metal element 371 is pushed by one paper sheet S. As the metal element 371 is swung, the electromagnetic effect generated by the coil 372 is subjected to a change. Since two paper sheets S are transferred through the document detecting module 37, the magnetic force value detected by the detecting circuit 373 is changed from the first magnetic force value to the corresponding second magnetic force value (e.g. A+2B).

Meanwhile, the change amount (i.e. 2B) between the first magnetic force value and the second magnetic force value is compared with the predetermined magnetic force value by the controlling unit 374. Since the change amount is larger than the predetermined magnetic force value, the controlling unit 374 judges that the multi feeding condition occurs. Under this circumstance, the controlling unit 374 issues a control signal. In response to the control signal, the pick-up roller 382, the separation roller 383 and the conveying roller assembly 39 are reversely rotated. Consequently, the two paper sheets S are returned to the document input tray 34. Then, the reverse rotations of the pick-up roller 382, the separation roller 383 and the conveying roller assembly 39 are stopped. Then, the paper sheet S is fed into the conveying channel 36. That is, the feeding procedure is repeatedly done. The situation that the multi feeding condition occurs has been mentioned above.

The processes of scanning the remaining paper sheets S are similar to the above process, and are not redundantly described herein. After the plural paper sheets S are scanned, the plural paper sheets S may be removed from the document discharge tray 35.

Since the type and thickness of the paper sheet to be fed at each feeding procedure may be different, it is necessary to set a corresponding predetermined magnetic force value according to the type of the paper sheets in order to enhance the judging accuracy of the controlling unit 374. That is, it is necessary to acquire the predetermined magnetic force value before each scanning task is performed. For acquiring the predetermined magnetic force value, the first magnetic force value when no paper sheet S is transferred through the document detecting module 37 and the second magnetic force value when one paper sheet S is transferred through the document detecting module 37 should be detected at first.

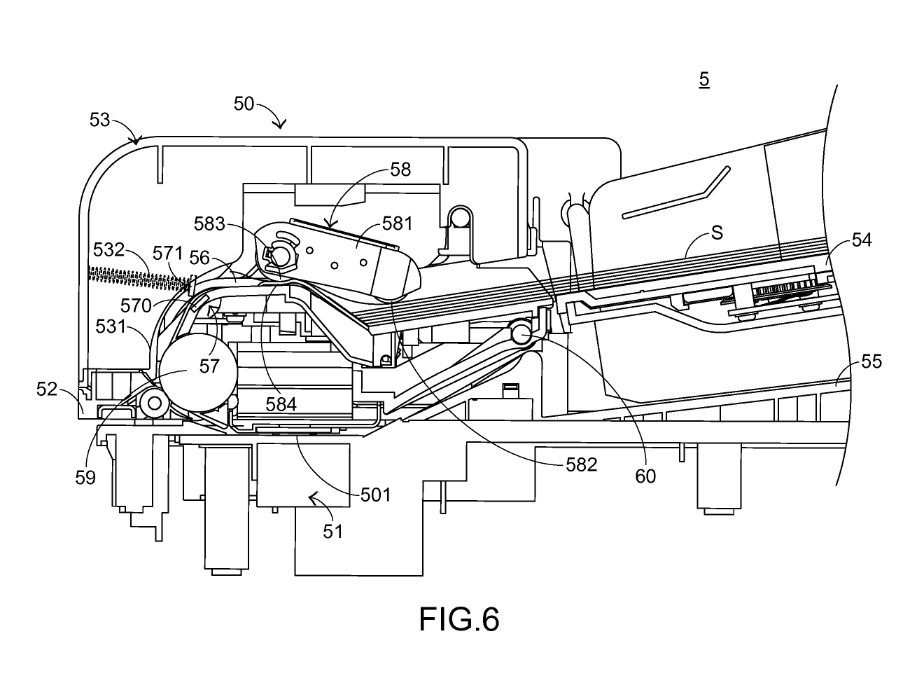

The present invention further provides a second embodiment, which is distinguished from the first embodiment. FIG. 6 is a schematic side view illustrating a sheet-feeding type scanning apparatus with an automatic document feeder according to a second embodiment of the present invention, in which the automatic document feeder is in a feeding status. As shown in FIG. 6 a sheet-feeding type scanning apparatus 5 comprises an automatic document feeder 50 and a scanning module 51. The scanning module 51 has a scan region 501. As shown in FIG. 6, the automatic document feeder 50 comprises a main body 52, an upper cover 53, a document input tray 54, a document discharge tray 55, a conveying channel 56, a document detecting module 57, a document pick-up module 58, a conveying roller assembly 59, and a document discharge roller assembly 60. The document pick-up module 58 comprises a pick-up arm 581, a pick-up roller 582, a separation roller 583, and a friction element 584. The document detecting module 57 comprises a metal element 571, a coil (not shown), a detecting circuit (not shown), and a controlling unit (not shown). Moreover, the coil, the detecting circuit and the controlling unit are integrated into a circuit board 570. Except for the arrangement of the metal element 571, the configurations and operations of the automatic document feeder 50 of this embodiment are similar to those of the first embodiment, and are not redundantly described herein. The arrangement of the metal element 571 will be illustrated as follows.

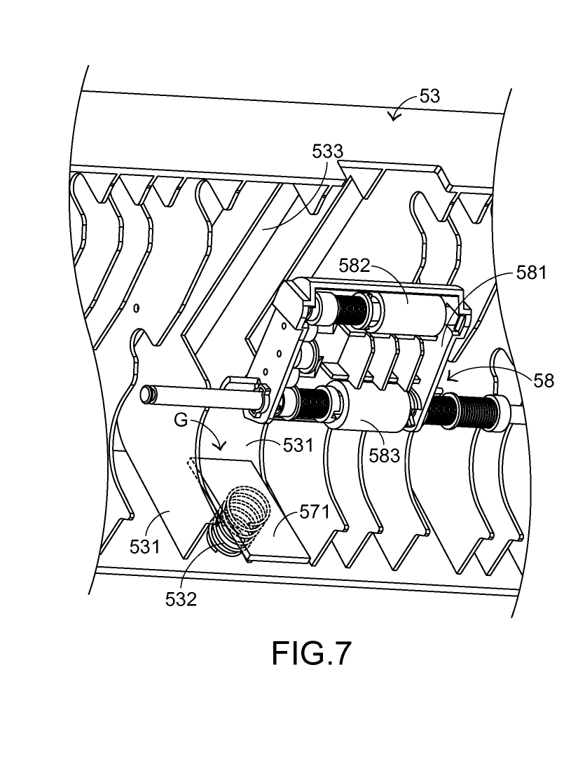

FIG. 7 schematically illustrates the upper cover and the metal element of the automatic document feeder according to the second embodiment of the present invention. Please refer to FIGS. 6 and 7. The upper cover 53 comprises plural guide slices 531 and an elastic element 532. The plural guide slices 531 are disposed on an inner surface 533 of the upper cover 53. Moreover, the plural guide slices 531 are perpendicular to the inner surface 533 of the upper cover 53. When the main body 52 is partially covered by the upper cover 53, the plural guide slices 531 are disposed over the conveying channel 56. The elastic element 532 is disposed on the inner surface 533 of the upper cover 53, and accommodated within a gap G between two of the plural guide slices 531. The metal element 571 is fixed on the elastic element 532. Consequently, the metal element 571 is located at the first side of the conveying channel 56. In this embodiment, an example of the metal element 571 includes but is not limited to a metal plate, and an example of the elastic element 532 includes but is not limited to a spring. In some other embodiments, the metal element is a metal block.

A process of transferring the paper sheets S through the document detecting module 57 will be illustrated as follows. After the pick-up operation as described in the first embodiment is performed by the automatic document feeder 50, one paper sheet S is fed into the conveying channel 56. While the paper sheet S is transferred through the document detecting module 57, the metal element 571 at the first side of the conveying channel 56 is pushed by the paper sheet S. In response to the pushing force of the paper sheet S, the metal element 571 is moved toward the upper cover 53. Since the elastic element 532 is pressed by the metal element 571, the elastic element 532 is in a compressed state. As the metal element 571 is moved, the electromagnetic effect generated by the coil 572 is subjected to a change. Since one paper sheet S is transferred through the document detecting module 57, the magnetic force value detected by the detecting circuit is changed from the first magnetic force value to the second magnetic force value (e.g. A+B). Meanwhile, the change amount (i.e. B) between the first magnetic force value and the second magnetic force value is compared with the predetermined magnetic force value by the controlling unit. Since both of the change amount and the predetermined magnetic force value are equal to B, the controlling unit judges that the feeding condition is normal. Under this circumstance, the feeding procedure is continuously performed. After the paper sheet S is completely transferred through the document detecting module 57, the metal element 571 is no longer pushed by the paper sheet S. Consequently, the elastic element 532 is restored from the compressed state to an original shape while providing an elastic force to the metal element 571. In response to the elastic force, the metal element 571 is moved to the original position where the metal element 571 is not swung. Meanwhile, the magnetic force value detected by the detecting circuit is changed to the first magnetic force value again.

Next, the pick-up operation as described in the first embodiment is performed by the automatic document feeder 50, and two paper sheets S are fed into the conveying channel 56. While the two paper sheets S are transferred through the document detecting module 57, the two paper sheets S at the first side of the conveying channel 56 are pushed by the two paper sheets S. In response to the pushing forces of the two paper sheets S, the metal element 571 is moved toward the upper cover 53. Since the elastic element 532 is pressed by the metal element 571, the elastic element 532 is in a compressed state. As the metal element 571 is moved, the electromagnetic effect generated by the coil 572 is subjected to a change. Since two paper sheets S are transferred through the document detecting module 57, the magnetic force value detected by the detecting circuit is changed from the first magnetic force value to the corresponding second magnetic force value (e.g. A+2B). Since the change amount of the magnetic force value is larger than the predetermined magnetic force value, the controlling unit judges that the multi feeding condition occurs. Under this circumstance, the controlling unit issues a control signal. In response to the control signal, the pick-up roller 582, the separation roller 583 and the conveying roller assembly 59 are reversely rotated. Consequently, the two paper sheets S are returned to the document input tray 54. The subsequent procedures of the automatic document feeder 50 of this embodiment are similar to those of the first embodiment, and are not redundantly described herein.

It is noted that the automatic document feeder of the present invention is not only applied to the scanning apparatus. The document detecting module of the automatic document feeder may be applied to a scanning apparatus, a multifunction peripheral or a shredder. The operations are similar to those mentioned above, and are not redundantly described herein.

From the above descriptions, the automatic document feeder of the present invention may judge whether a multi feeding condition occurs according to a change amount of the magnetic force value while the paper sheet or the paper sheets are transferred through the document detecting module. In case that the multi feeding condition occurs, the paper sheets are returned to the document input tray. Consequently, the problem of resulting in missing pages will be avoided. Moreover, the document detecting module of the present invention only comprises the metal element, the coil, the detecting circuit and the controlling unit. In other words, the document detecting module has simple configurations and can be easily operated. When the automatic document feeder is equipped with the document detecting module, the cost is not considerably increased (e.g. about $2 dollars). In other words, the document detecting module is cost-effective. Consequently, even if the multi feeding condition occurs, the automatic document feeder of the present invention is capable of avoid missing pages.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. An automatic document feeder for successively transferring plural paper sheets to a scan region of a scanning module, the automatic document feeder comprising:
a main body;
an upper cover partially covering the main body;
a document input tray connected with the main body, wherein plural paper sheets are placed on the document input tray;
a document discharge tray disposed on the main body, wherein after the plural paper sheets are transferred through the scan region, the plural paper sheets are placed on the document discharge tray;
a conveying channel arranged between the document input tray and the document discharge tray and disposed under the upper cover, wherein the plural paper sheets are permitted to be transferred through the conveying channel; and
a document detecting module disposed in the conveying channel, and detecting whether a multi feeding condition occurs, wherein the document detecting module comprises:
a metal element located at a first side of the conveying channel;
a coil located at a second side of the conveying channel, and generating a magnetic force in response to an electromagnetic effect;
a detecting circuit located at the second side of the conveying channel and connected with the coil, wherein the detecting circuit provides an electric current to the coil to have the coil generate the electromagnetic effect, or the detecting circuit detects a first magnetic force value or a second magnetic force value when the metal element is not pushed by any paper sheet or the metal element is pushed by one or more of the plural paper sheets;
a controlling unit located at the second side of the conveying channel and connected with the detecting circuit, wherein the controlling unit judges whether the multi feeding condition occurs according to a change amount between the first magnetic force value and the second magnetic force value, wherein if the charge amount is larger than a predetermined magnetic force value, the controlling unit judges that the multi feeding condition occurs;
a document pick-up module arranged between the document input tray and the conveying channel, wherein the plural paper sheets on the document input tray are successively fed into the conveying channel by the document pick-up module;
a conveying roller assembly disposed in the conveying channel, wherein the plural paper sheets are successively transferred to the scan region by the conveying roller assembly; and
a document discharge tray, wherein after the plural paper sheets are transferred across the scan region, the plural paper sheets are ejected to the document discharge tray, wherein if the controlling unit judges that the multi feeding condition occurs, the document pick-up module and the conveying roller assembly are reversely rotated, so that the paper sheets transferred through the document detecting module are returned to the document input tray.

2. The automatic document feeder according to claim 1, wherein the upper cover comprises plural guide slices, and the plural guide slices are disposed on an inner surface of the upper cover and disposed over the conveying channel, wherein the metal element is arranged between two of the plural guide slices, a first end of the metal element is fixed on the two guide slices, and a second end of the metal element is located at the first side of the conveying channel, wherein while one or more of the plural paper sheets are moved along the conveying channel and transferred through the document detecting module, the second end of the metal element is pushed and swung relative to the first end of the metal element, so that the second magnetic force value is detected by the detecting circuit.

3. The automatic document feeder according to claim 1, wherein the upper cover comprises:
plural guide slices disposed on an inner surface of the upper cover, and disposed over the conveying channel; and
an elastic element disposed on the inner surface of the upper cover, and accommodated within a gap between two of the plural guide slices, wherein the metal element is fixed on the elastic element, so that the metal element is located at the first side of the conveying channel, wherein while one or more of the plural paper sheets are moved along the conveying channel and transferred through the document detecting module, the metal element is pushed and moved relative to the conveying channel, so that the second magnetic force value is detected by the detecting circuit.

4. The automatic document feeder according to claim 1, wherein if the metal element is not pushed by any paper sheet, the first magnetic force value is detected by the detecting circuit, wherein if the metal element is pushed by one of the plural paper sheets, the second magnetic force value is detected by the detecting circuit and the change amount between the first magnetic force value and the second magnetic force value is equal to the predetermined magnetic force value, so that a normal feeding condition is realized by the controlling unit, wherein if the metal element is pushed by two or more of the plural paper sheets, the second magnetic force value is detected by the detecting circuit and the change amount between the first magnetic force value and the second magnetic force value is larger than the predetermined magnetic force value, so that the multi feeding condition is realized by the controlling unit.

5. The automatic document feeder according to claim 4, wherein if the metal element is pushed by one of the plural paper sheets, the second magnetic force value is obtained, and the change amount between the first magnetic force value and the second magnetic force value is set as the predetermined magnetic force value by the controlling unit.

6. (canceled)

7. The automatic document feeder according to claim 3, wherein the document pick-up module comprises:
a pick-up arm disposed over the first side of the conveying channel, and swingable relative to the conveying channel;
a pick-up roller disposed on the pick-up arm, wherein as the pick-up arm is swung, the pick-up roller is contacted with the plural paper sheets, so that the plural paper sheets are successively fed into the conveying channel by the pick-up roller;
a separation roller disposed on the pick-up arm and arranged beside the pick-up roller, wherein the plural paper sheets are separated by the separation roller, so that only one of the plural paper sheets is allowed to be fed into the conveying channel; and
a friction element located at a second side of the conveying channel, wherein the friction element provides a frictional force to the plural paper sheets, thereby assisting in separating the plural paper sheets.

8. The automatic document feeder according to claim 7, wherein the friction element is a friction roller or a friction pad.

9. The automatic document feeder according to claim 1, wherein the metal element is a metal sheet, a metal plate or a metal block.

10. The automatic document feeder according to claim 1, wherein the coil, the detecting circuit and the controlling unit are integrated into a circuit board.
